(19) United States
(12) Patent Application Publication
(10) Pub. No.: US 2010/0196736 A1
(43) Pub. Date: Aug. 5, 2010

(54) Vibration-damping composite component

(75) Inventors: Thorsten Böger, Duisburg (DE); Oliver Kleinschmidt, Dortmund (DE); Lothar Patberg, Moers (DE)

Correspondence Address: PROSKAUER ROSE LLP, ONE INTERNATIONAL PLACE, BOSTON, MA, 02110, US

(73) Assignee: ThyssenKrupp Steel Europe AG, Duisburg (DE)

(21) Appl. No.: 12/674,499

(22) PCT Filed: Aug. 28, 2008
(86) PCT No.: PCT/EP08/61321

§ 371 Date: Mar. 18, 2010

(30) Foreign Application Priority Data
Aug. 31, 2007 (DE) 10 2007 041 484.8

(51) Int. Cl. B32B 15/08; B32B 7/12; B32B 15/00; F16F 9/00

(52) U.S. Cl. 428/621; 428/339; 428/198; 428/457; 428/411.1; 428/174

(57) ABSTRACT

A composite component comprising at least one base plate and at least one sandwich component which is arranged on the base plate provides the composite component with very satisfactory vibration-damping properties which can additionally be produced in a simple way and at the same time is suitable for lightweight design concepts. The vibration damping properties of the composite component are achieved by the fact that the sandwich component has at least two outer plates and at least one plastic layer which is arranged between the two outer plates.

### CROSS-REFERENCE TO RELATED APPLICATIONS

This application is a National Phase Application of International Application No. PCT/EP2008/061321, filed on Aug. 28, 2008, which claims the benefit of and priority to German patent application no. DE 10 2007 041 484.8-16, filed on Aug. 31, 2007. The disclosures of the above applications are incorporated herein by reference in their entirety.

### FIELD OF THE INVENTION

The invention relates to a composite component comprising at least one base sheet and at least one sandwich component arranged on the base sheet and to an advantageous use of the composite component according to the invention.

### BACKGROUND

Numerous composite components are known from the prior art, which are designed, for example, as double sheets or patched sheets, i.e. sheets having local additional panels. For example, a method is known from DE 43 07 563 for producing a composite component, in which a base sheet is deep-drawn together jointly with a reinforcement sheet after the reinforcement sheet has been joined to the base sheet. The composite component produced in this way has greater component rigidity. However, the vibration-reducing properties of the known composite component are improvable, so that the use of a corresponding composite component, for example as a front wall in a motor vehicle, is only possible by means of vibration-reducing measures. Vibration-reducing composite components are also known from the prior art, in which polymer heavy mats (damping) and/or absorbing materials (for example a non-woven fabric) are applied on a base sheet. However, the known vibration-reducing composite component is relatively heavy.

### SUMMARY OF THE INVENTION

In general, a first aspect of the present invention is to provide a composite component having very good vibration-reducing properties, which can be produced in a simple way and is suitable for lightweight construction designs. Moreover, a second aspect of the invention is to propose advantageous uses for the composite components according to the invention.

According to a first teaching of the present invention, the above disclosed aspect is achieved by means of a generic composite component by the sandwich component having at least two outer sheets and at least one plastic layer arranged between the sheets.

It has been demonstrated that the plastic layer arranged between both sheets of the sandwich structure produces good vibration-reducing properties for the composite component and thereby assumes the properties of an absorber mass without having a high mass. Corresponding sandwich components having a plastic layer arranged between two sheets can be produced relatively easily. In addition, as already stated, the mass can be kept low, despite very good vibration-reducing properties, so that composite components according to the invention can also be used for lightweight construction designs.

The vibration-reducing properties of the composite component according to the invention can be further improved by the plastic layer consisting of a visco-elastic polymer. Through this, the mechanical energy introduced into the sandwich component by the vibrations of the base sheet is absorbed very well and the vibrations received by the sandwich component are damped.

According to a refined embodiment of the composite component according to the invention, the sandwich component has a structure increasing the rigidity of the composite component. Structures considered which increase the rigidity are, for example, profiles, bulges, embossings, creases and/or beads. The sheet thicknesses for the sandwich component can be further reduced by the corresponding structures, so that a further saving in weight is obtained.

Preferably, the sandwich component is joined to the base sheet in a firmly bonded manner by welding, gluing or soldering. The firmly bonded join produces maximum rigidity in the composite component according to the invention. In contrast to soldering and welding, the acoustic properties of the composite component can be improved still further by gluing because with gluing, due to the different materials, i.e. metal and adhesive, vibration energy can be absorbed when vibrations are transferred from the sheet to the sandwich component. When sandwich component and base sheet are glued together over a large area, the deformation energies which occur in the event of a crash can, in particular for crash-relevant components in the motor vehicle, be discharged into the sandwich component over a large area. The crash behavior of the composite component can thereby be improved further.

According to a subsequent embodiment of the composite component according to the invention, an epoxy resin is provided to glue the sandwich component to the base sheet, wherein its layer thickness is preferably a maximum of 0.5 mm, particularly preferably a maximum of 0.3 mm. Epoxy resins can, for example, be thermally hardened, so that the bond between sandwich component and base sheet can be obtained by simply heating both components. The highest bond strengths between base sheet and sandwich component are produced with layer thicknesses of a maximum of 0.5 mm or a maximum of 0.3 mm. Preferably, the application of heat, which usually takes place in the range from 140 to 220° C., can be carried out after a cathodic dip coating, so that the manufacturing process for the composite component according to the invention can be easily integrated into existing production processes, in particular in the bodyshell construction. Gluing of the sandwich component can also be carried out with an oiled base sheet, wherein measures for removing the passive corrosion protection layer can be dispensed with, as craters can thereby be confined.

The vibration-reducing properties of the composite component according to the invention can be improved further by using a rubber or polyurethane-based adhesive to glue the sandwich component to the base sheet, the layer thickness of which is preferably a maximum of 5 mm, in particular a maximum of 3 mm. If polyurethane is used, a first firm bond between base sheet and sandwich component can be obtained by the action of moisture, so that the sandwich component can be fixed on the base sheet before the final hardening of the bond. The bond between base sheet and sandwich component can be hardened by targeted application of heat, so that a relatively stress-free bond is obtained between base sheet and sandwich component. It is also possible for a cold-hardening bonding, for example on already coated base sheets, to be provided, in particular if no heat treatment, such as for example a cathodic dip coating, is to be gone through.

Preferably, the base sheet is shaped before being joined to the sandwich component, in order, for example, to increase the rigidity of the composite component further.

As an alternative to gluing, the sandwich component can be joined to the base sheet by spot, laser or resistance welding. In the case of resistance welding, the layer between the two sheets of the sandwich component must, for this purpose, be designed to be conductive. All the welding processes mentioned have in common the fact that they can be carried out in a highly automated and flexible manner, so that their use can, in principle, reduce the costs of producing a composite component according to the invention.

Improved conformance to the application conditions of the composite component according to the invention is obtained by providing a plurality of sandwich structures on the base sheet.

According to a subsequent embodiment of the composite component according to the invention, the base sheet and/or the sandwich component consist of sheets of steel or a steel alloy, in order to guarantee the strength required, for use, for example, in automotive engineering.

Preferably, at least one sheet of the composite component is at least partly metallically and/or organically coated. Certain properties of the composite component according to the invention can be improved by means of the coatings. For example, improved corrosion resistance is achieved by galvanizing the sheets. However, this can also be accomplished by means of an organic coating.

According to a second teaching of the present invention, the above disclosed second aspect is achieved by the use of a component according to the invention in automotive engineering, in particular as a front wall of a motor vehicle. As has already been stated previously, the composite component according to the invention has advantageous properties regarding vibration damping with, at the same time, a high level of component rigidity and low weight. Moreover, the sandwich component arranged on the base sheet can also serve as a protection against impact penetration. The front wall, which separates the passenger cabin from the engine compartment, is therefore a typical application for the composite component according to the invention. However, other applications in automotive engineering for the composite component according to the invention are also conceivable, provided that the installation space is available. Due to the reinforcing and, at the same time, vibration-reducing properties of the sheet, the use of the composite component according to the invention is also advantageous in the floor panel of a motor vehicle body, preferably in the tunnel area, in the back wall area, i.e. the separating wall between passenger compartment and boot or loading area and, for example, the rear window shelf. In the areas of use mentioned, on the one hand undesired vibrations occur and, on the other hand, at the same time a high level of component rigidity is required.

### BRIEF DESCRIPTION OF THE DRAWINGS

There are a number of possible embodiments of the composite component according to the invention. For illustration purpose, reference is made to the description of two such exemplary embodiments in conjunction with the drawing. In the drawing

FIG. 1 shows a schematic sectional view of a vibration-reducing composite component known from the prior art,

FIGS. 2a) and b) show schematic sectional views of two exemplary embodiments of the composite component according to the invention and

FIGS. 3a) and b) show schematic sectional views of two further exemplary embodiments of the composite component according to the invention.

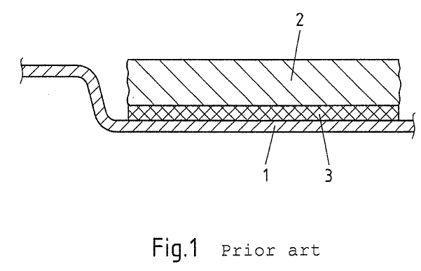

FIG. 1 shows a composite component known from the prior art having good vibration-reducing properties. The composite component illustrated consists of a base sheet 1 and a damping material 2 attached to it (for example a non-woven fabric) and a heavy layer 3 (damping mat) arranged between base sheet 1 and damping material 2. The damping mat 3 must have a relatively high mass to provide the damping properties of the known composite component, in order to damp vibrations which are released. From this it is clear that the vibration-reducing composite components used up to now have been relatively heavy for lightweight construction designs. Moreover, the component rigidity of the composite component, illustrated in FIG. 1, needs to be improved.

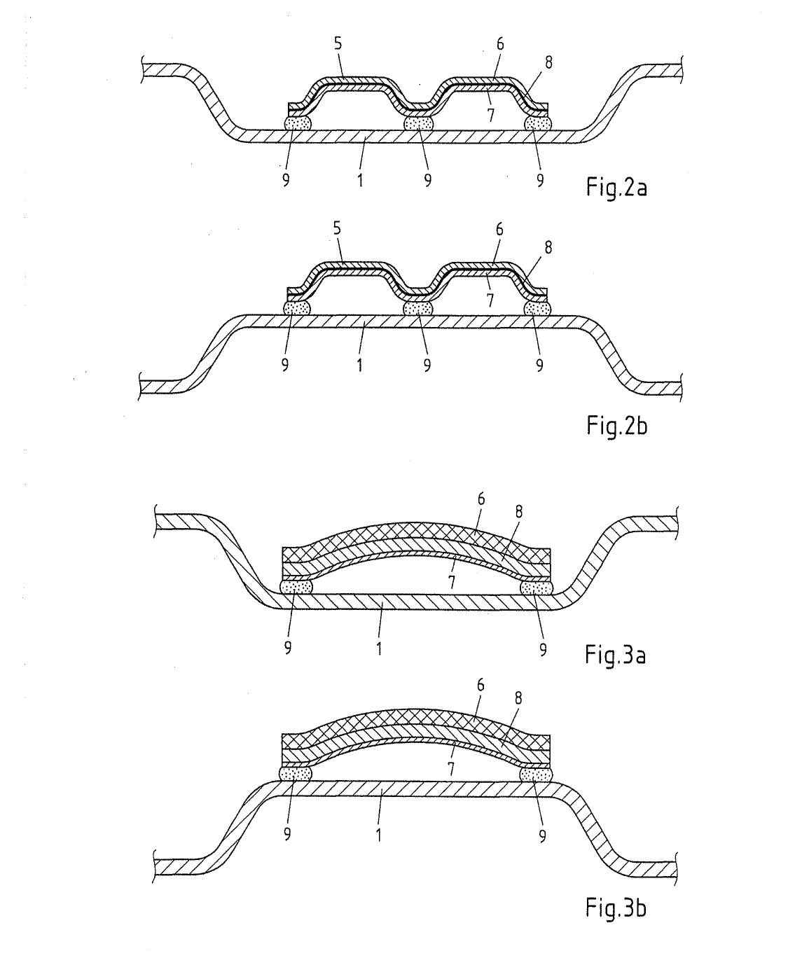

FIG. 2 now shows an exemplary embodiment of a composite component according to the invention consisting of a base sheet 1 and a sandwich component 5, which consists of a first sheet 6, a second sheet 7 and a plastic layer 8 located between them. In addition, the sandwich component 5 has a structure which serves to increase the rigidity of the exemplary embodiment of the composite component according to the invention. To improve the acoustic properties, the sandwich component is joined to the base sheet 1 by means of adhesive bonding points 9. An additional damping of vibrations occurs at the adhesive bonding points 9 due to the change of material between the metal of the base sheet 1, the adhesive bonding point 9 and the sandwich component 5. As FIG. 2a) further shows, the base sheet 1 has been shaped to accommodate the sandwich component 5. A further increase in composite component rigidity is obtained by the sandwich component arrangement according to FIG. 2b).

The sandwich component 5 is designed such that two sheets 6, 7 of equal thickness, for example of 0.5 mm, are joined to a visco-elastic polymer layer having a thickness of, for example, 50 μm. The polymer layer can, according to the application, be 15 μm to 1500 μm, preferably 25 μm to 50 μm. The sheet thicknesses of the sheets 6, 7 can vary between 0.2 mm and 2 mm.

A positive effect on the vibration-reducing properties is achieved by the bond between the base sheet 1 and the sandwich component 5 being effected by an epoxy resin adhesive 9 having a layer thickness of approximately 0.2 mm. In the bodyshell construction, the base sheet 1 is, for example, in an oiled state. The adhesive bonds between the sandwich component 5 and the base sheet 1 absorb vibrations which are transferred from the base sheet 1 to the sandwich component 5 and act to the extent that they additionally reduce vibrations. To harden the bond between the base sheet 1 and the sandwich component 5, the entire composite component is heated to 180° C., for example after a cathodic dip coating.

A further exemplary embodiment of the composite component according to the invention is now illustrated in FIG. 3, which, in contrast to the exemplary embodiment from FIG. 2, consists of sheets 6, 7 having different thicknesses. The visco-elastic polymer layer 8 in the present exemplary embodiment is, for example, 0.5 mm, whilst the sheet thickness of the first sheet 6 is 1.2 mm and the sheet thickness of the second sheet 7 is approximately 0.5 mm. The thicknesses of the layers here are not shown to scale. Additional vibration-reducing requirements can, in particular, be met by the structure of the sandwich component 5. The sandwich component 5 can, however, also serve as a protection against impact penetration when using the composite component in a or as a front wall which, for example, separates the passenger compartment of a motor vehicle from the engine compartment, in order to improve the safety of the passenger cabin.

The embodiment of the composite component according to FIG. 3b) produces a significantly higher level of rigidity than the design in FIG. 3a). The arrangement of the sandwich component is in each case dependent on the corresponding assembly circumstances, in which, however, both designs according to FIGS. 3a) and b) have sufficient vibration-reducing properties.

In these examples, adhesives are considered which are cold-hardening and are applied primarily to coated sheets, for example after a cathodic dip coating.

What is claimed is:

1. Composite component comprising at least one base sheet and at least one sandwich component arranged on the at least one base sheet, wherein the at least one sandwich component has at least two outer sheets and at least one plastic layer arranged between the at least two outer sheets, the at least one sandwich component additionally has a structure increasing the rigidity of the composite component.

2. Composite component according to claim 1, wherein the at least one plastic layer consists of a visco-elastic polymer.

3. Composite component according to claim 1, wherein the at least one sandwich component is joined to the at least one base sheet in a firmly bonded manner by welding, gluing or soldering.

4. Composite component according to claim 1, wherein an epoxy resin is provided to glue the at least one sandwich component to the at least one base sheet, wherein layer thickness of the epoxy resin is a maximum of 0.5 mm.

5. Composite component according to claim 1, wherein a polyurethane-based adhesive is used to glue the at least one sandwich component to the at least one base sheet, a layer thickness of which is a maximum of 5 mm.

6. Composite component according to claim 1, wherein the at least one base sheet is shaped before being joined to the at least one sandwich component.

7. Composite component according to claim 1, wherein the at least one sandwich component is joined to the at least one base sheet by spot, laser or resistance welding.

8. Composite component according to claim 1, wherein a plurality of sandwich components are arranged on the at least one base sheet.

9. Composite component according to claim 1, wherein the at least one base sheet and/or the at least one sandwich component consist of sheets of steel or a steel alloy.

10. Composite component according to claim 1, wherein the at least one base sheet and/or one or more of the at least two outer sheets of the composite component is at least partly metallically and/or organically coated.

11. (canceled)
